(19) United States
(12) Patent Application Publication
(10) Pub. No.: US 2026/0340305 A1
(43) Pub. Date: Oct. 29, 2026

(54) SYSTEMS AND METHODS FOR AUTOMATIC GENERATION AND REFINING OF LLM PROMPTS

(71) Applicant: ServiceNow, Inc., Santa Clara, CA (US)

(72) Inventors: Ian Anthony Flynn, San Diego, CA (US); Chia-Chuan Wu, Santa Clara, CA (US); Akanksha Aggarwal, Santa Clara, CA (US); Edwin Sapugay, Foster City, CA (US)

(21) Appl. No.: 19/188,839

(22) Filed: Apr. 24, 2025

(51) Int. Cl. G06F 40/40

(52) U.S. Cl. CPC G06F 40/40

(57) ABSTRACT

This disclosure is directed to a system and a method for refining an LLM prompt. In an embodiment of this disclosure, the method may be practiced by receiving a skill prompt and a task description and generating a first set of prompts based on the skill prompt and the task description. Then, the method includes, for each prompt of the first set of prompts, generating, via a large language model (LLM), a respective response based on the respective prompt and determining feedback associated with the respective response via a plurality of judge models. The method includes generating a second set of prompts based on the first set of prompts and the respective feedback associated with each prompt of the first set of prompts. Lastly, the method includes, for each prompt of the second set of prompts, generating, via the LLM, a respective response based on the respective prompt.

### TECHNICAL FIELD

The present disclosure relates generally to systems and methods for automatically generating and refining LLM prompts.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Artificial intelligence (AI) models may be configured to generate outputs in response to prompts. Prompts may be generated based on user queries using prompt templates. Each AI model may be developed using different techniques such that each AI model may respond differently to a given prompt. For example, in response to a particular prompt, a first AI model outputs a response that is “good” (e.g., accurate, concise), while a second AI model outputs a response that is lengthy, inaccurate, incomplete, irrelevant, or any combination thereof. Therefore, prompts may be manually refined for each AI model. However, manually refining prompts may be time consuming, labor intensive, and require excessive computational resources.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment of this disclosure, a method may be practiced by receiving a skill prompt and a task description; generating a first set of prompts based on the skill prompt and the task description; for each prompt of the first set of prompts, generating, via a large language model (LLM), a respective response based on the respective prompt and determining feedback associated with the respective response via a plurality of judge models; generating a second set of prompts based on the first set of prompts and the respective feedback associated with each prompt of the first set of prompts; and for each prompt of the second set of prompts, generating, via the LLM, a respective response based on the respective prompt.

In an embodiment of this disclosure, a system may include processing circuitry and a non-transitory memory accessible by the processing circuitry. The non-transitory memory may store instructions that, when executed by the processing circuitry, cause the processing circuitry to perform operations including: receiving a skill prompt and a task description; generating a first set of prompts based on the skill prompt and the task description; for each prompt of the first set of prompts, generating, via a large language model (LLM), a respective response based on the respective prompt and determining feedback associated with the respective response via a plurality of judge models; generating a second set of prompts based on the first set of prompts and the respective feedback associated with each prompt of the first set of prompts; and for each prompt of the second set of prompts, generating, via the LLM, a respective response based on the respective prompt.

In an embodiment of this disclosure, a non-transitory, computer readable medium includes instructions that, when executed by processing circuitry, cause the processing circuitry to perform operations including: receiving a skill prompt and a task description; generating a first set of prompts based on the skill prompt and the task description; for each prompt of the first set of prompts, generating, via a large language model (LLM), a respective response based on the respective prompt and determining feedback associated with the respective response via a plurality of judge models; generating a second set of prompts based on the first set of prompts and the respective feedback associated with each prompt of the first set of prompts; and for each prompt of the second set of prompts, generating, via the LLM, a respective response based on the respective prompt.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a multi-instance cloud architecture in which embodiments of the present disclosure may operate;

FIG. 2 is a schematic diagram of an embodiment of a multi-instance cloud architecture in which embodiments of the present disclosure may operate;

FIG. 3 is a block diagram of a computing device utilized in a computing system that may be present in FIGS. 1 or 2, in accordance with aspects of the present disclosure;

FIG. 4 is a block diagram illustrating an embodiment in which a virtual server supports and enables a client instance and hosts a prompt tuning tool, in accordance with aspects of the present disclosure;

FIG. 5 is a block diagram of a process for automatically, iteratively refining a set of prompts for an LLM via the prompt tuning tool of FIG. 4, in accordance with aspects of the present disclosure; and

FIG. 6 is a flow chart of a process for automatically refining a set of prompts over a number of iterations via the prompt tuning tool of FIG. 4, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers’ specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “computing system” refers to an electronic computing device such as, but not limited to, a single computer, virtual machine, virtual container, host, server, laptop, and/or mobile device, or to a plurality of electronic computing devices working together to perform the function described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code.

Prompt engineering is an iterative manual process wherein AI-generated responses to a prompt are evaluated to identify deficiencies and the prompt is refined to mitigate the deficiencies. Prompt engineering may rely on predefined datasets to evaluate the responses, which may fail to capture the variability and complexities of user interactions. Additionally, prompt engineering may be time and labor intensive. Accordingly, new techniques for prompt engineering are needed.

Various embodiments disclosed herein are directed to a system and method for autonomously refining AI prompts. In some embodiments, the system may receive a dataset including text, strings, queries, sample responses, and the like. The system may split the dataset into a training set (e.g., a first subset), a validation set (e.g., a second subset), and a testing set (e.g., a third subset). The system may receive a skill prompt (e.g., summarize, locate, etc.) and a task description. The system may conduct a search (e.g., a wide net search, a scatter shot search, a semantic search) based on the skill prompt and task description to generate a first set of candidate prompts. Additionally and/or alternatively, the system may generate the first set of candidate prompts via a prompt generation model (e.g., a large language model (LLM)).

Once the set of candidate prompts are generated, the system may then evaluate the effectiveness of each prompt. In some embodiments, for each prompt of the set of candidate prompts, the system may generate a respective response using the prompt and the training data. In particular, the system may iterate through the training set, at each iteration providing the prompt, the skill prompt, the task description, and a query of the training set to a model (e.g., an LLM) to generate a respective response.

In some embodiments, the system may compare the respective response to the validation set. For example, the system may determine whether the respective response is within a similarity threshold of the validation set. Additionally, the system may determine a validation score for the respective response based on the similarity of the respective response to the validation set.

In some implementations, the system may analyze the respective response via a plurality of judge models. Each of the judge models may be a respective LLM trained to provide a grade and a comment (collectively, feedback) for the respective response for a particular response trait. For example, the response traits may include formatting, coherency of response, completeness of response, conciseness of response, groundedness (e.g., hallucination detection, accuracy of information in response), relevance to the skill prompt and/or task description, citation accuracy, lack of grammatical errors, and the like. In some embodiments, the system may remove or add judge models for particular response traits. For example, the system may remove a judge model evaluating conciseness if a length of the response is not restricted. Alternatively, the system may add a judge model evaluating conciseness if a short response is required. In some embodiments, each response trait may be associated with an importance score (e.g., a multiplier or other weighting mechanism). The grade for each response trait for the respective response may be multiplied by its associated importance score to ensure the response trait is given appropriate weight. The system may sum or average each grade for each response trait for the respective response to determine an overall grade for the response. Additionally, the system may summarize the comments associated with the respective response for each response trait via a language model.

For each prompt of the first set of candidate prompts, the system may provide the first (i.e., initial) set of candidate prompts along with the respective summarized feedback for each of the respective responses, the respective grade for each of the respective responses, and the task description to a prompt generation model (e.g., LLM) to generate a second (i.e., subsequent) set of candidate prompts. In particular, the prompt generation model may be configured to generate a second set of candidate prompts that address the feedback associated with each prompt of the first set of candidate prompts. The system may provide the second plurality of candidate prompts and the training set to the model to generate a respective response for each of the second set of candidate prompts, as described above. The system may repeat the process (e.g., response analysis and evaluation, prompt generation) for a set number of cycles or until an nth prompt outputs responses that are not within a similarity threshold specified for the validation set.

The system may use the validation score and/or the grade to filter the candidate prompts into one or more filtered candidate prompts. In some embodiments, the system may output all of the filtered candidate prompts and receive an input (e.g., a user selection or automated selection) selecting which filtered candidate prompt to use. In some embodiments, the system may compare the responses associated with the filtered candidate prompts to the testing set (e.g., determine whether the responses are within a similarity threshold of the testing set) and output the filtered candidate prompt associated with the response with a highest similarity to the testing set.

The embodiments of this disclosure may provide a system for automatically refining AI prompts. As such, the system may reduce manual operations, automatically customize prompts for each language model, and improve the language model’s performance. Furthermore, the system may be configurable such that the prompts and responses may be customized for the particular task. For example, the system may add or remove judge models for certain response traits as appropriate to complete the task. The system may generate a set of prompts with varying scopes. The system may then evaluate a respective response for each of the set of prompts, allowing the system to concurrently evaluate the effectiveness of prompts with varying scopes. The system may evaluate the responses based on a variety of response traits. The system may generate feedback based on the evaluation including comments, which may be summarized and provided to a prompt generation model to generate improved prompts, and grades, which may be used to determine the effectiveness of the response. Additionally, each grade for a response trait may be multiplied by an importance score such that the system appropriately prioritizes the response traits. The system may generate an additional set of prompts with varying scope based on the set of prompts, the respective responses, and the feedback. Thus, the additional set of prompts may narrow in scope and result in improved responses that more accurately and effectively responds to the skill prompt.

The system may also use a dataset. For example, the LLM that generates the responses may be trained on a first subset of the dataset. The system may compare the responses to a second subset of the dataset to ensure the responses are not overfit to the first subset. Additionally, the system may determine one or more candidate responses to output based on the grades, the validation scores, and the training data such that the system outputs the response that most accurately and effectively responds to the skill prompt. The system may also compare the candidate responses to a third subset of the dataset to determine a response to output such that the computing system ensures the responses output by the system are accurate across the entire dataset. Furthermore, the system may store the response associated with the output response in a database of template prompts such that the refined prompt may be reused, thus reducing the resource consumption and the cost associated with generating refined prompts. Therefore, the system provides a consistent, automatic process that is reproducible, traceable, and time and resource efficient.

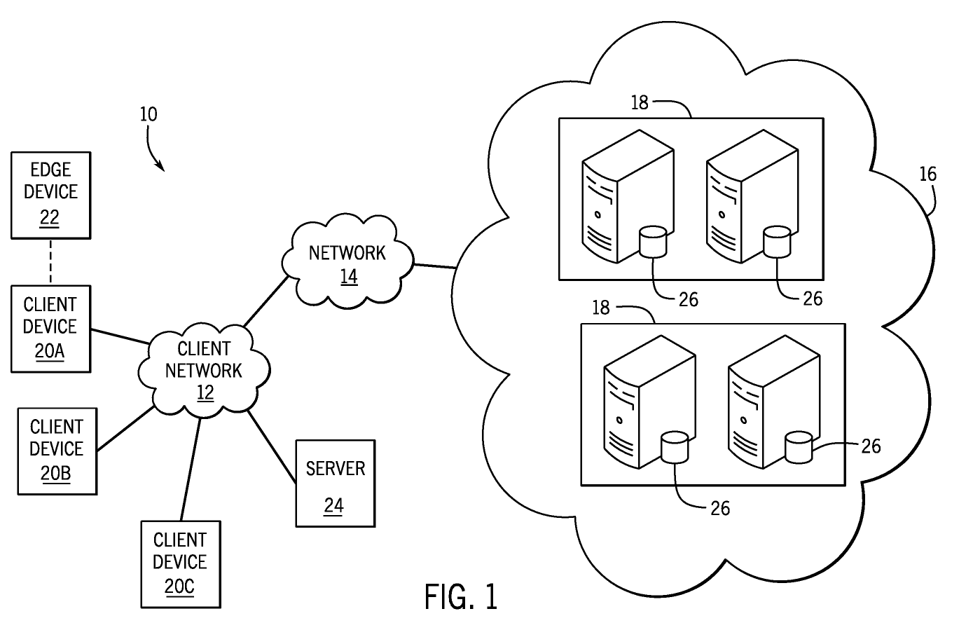

With the preceding in mind, the following figures relate to various types of generalized system architectures or configurations that may be employed to provide services to an organization in a multi-instance framework and on which the present approaches may be employed. Correspondingly, these system and platform examples may also relate to systems and platforms on which the techniques discussed herein may be implemented or otherwise utilized. Turning now to FIG. 1, a schematic diagram of an embodiment of a cloud computing system 10 where embodiments of the present disclosure may operate, is illustrated. The cloud computing system 10 may include a client network 12, a network 14 (e.g., the Internet), and a cloud-based platform 16. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, 20B, and 20C so that the client devices are able to communicate with each other and/or with the network hosting the platform 16. The client devices 20 may be computing systems and/or other types of computing devices generally referred to as Internet of Things (IoT) devices that access cloud computing services, for example, via a web browser application or via an edge device 22 that may act as a gateway between the client devices 20 and the platform 16. FIG. 1 also illustrates that the client network 12 includes an administration or managerial application, device, agent, or server, such as a management, instrumentation, and discovery (MID) server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to the network 14, which may include one or more computing networks, such as other LANs, wide area networks (WAN), the Internet, and/or other remote networks, to transfer data between the client devices 20 and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20 via the client network 12 and network 14. The network hosting the platform 16 provides additional computing resources to the client devices 20 and/or the client network 12. For example, by utilizing the network hosting the platform 16, users of the client devices 20 are able to build and execute applications and/or workflows for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to herein as application nodes, application servers, virtual server instances, application instances, or application server instances), where each virtual server 26 can be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

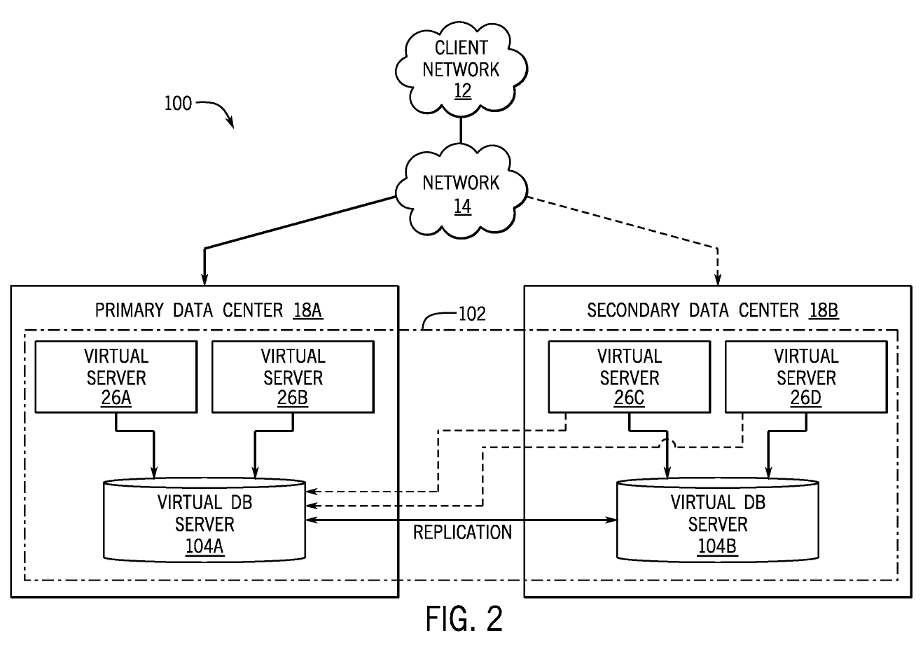

In another embodiment, one or more of the data centers 18 are configured using a multi-instance cloud architecture to provide every customer its own unique customer instance or instances. For example, a multi-instance cloud architecture could provide each customer instance with its own dedicated application server(s) and dedicated database server(s). In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 100 where embodiments of the present disclosure may operate. FIG. 2 illustrates that the multi-instance cloud architecture 100 includes the client network 12 and the network 14 that connect to two (e.g., paired) data centers 18A and 18B that may be geographically separated from one another and provide data replication and/or failover capabilities. Using FIG. 2 as an example, network environment and service provider cloud infrastructure client instance 102 (also referred to herein as a client instance 102) is associated with (e.g., supported and enabled by) dedicated virtual servers (e.g., virtual servers 26A, 26B, 26C, and 26D) and dedicated database servers (e.g., virtual database servers 104A and 104B). Stated another way, the virtual servers 26A-26D and virtual database servers 104A and 104B are not shared with other client instances and are specific to the respective client instance 102. In the depicted example, to facilitate availability of the client instance 102, the virtual servers 26A-26D and virtual database servers 104A and 104B are allocated to two different data centers 18A and 18B so that one of the data centers 18 acts as a backup data center. Other embodiments of the multi-instance cloud architecture 100 could include other types of dedicated virtual servers, such as a web server. For example, the client instance 102 could be associated with (e.g., supported and enabled by) the dedicated virtual servers 26A-26D, dedicated virtual database servers 104A and 104B, and additional dedicated virtual web servers (not shown in FIG. 2).

Although FIGS. 1 and 2 illustrate specific embodiments of a cloud computing system 10 and a multi-instance cloud architecture 100, respectively, this disclosure is not limited to the specific embodiments illustrated in FIGS. 1 and 2. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, edge devices, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

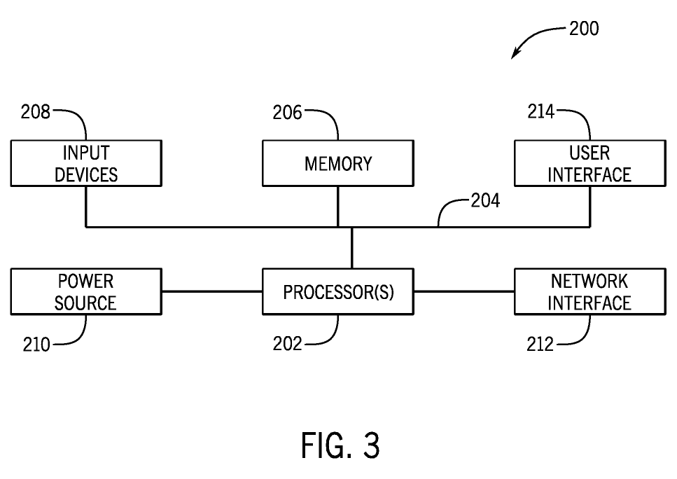

By way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computing system 200 may include some or all of the computer components depicted in FIG. 3. FIG. 3 generally illustrates a block diagram of example components of a computing system 200 and their potential interconnections or communication paths, such as along one or more busses. As illustrated, the computing system 200 may include various hardware components such as, but not limited to, one or more processors 202, one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like. The power source 210 can be any suitable source for power of the various components of the computing device 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202. In addition and/or alternative to the display, the user interface 214 may include other devices for interfacing with a user, such as lights (e.g., LEDs), speakers, and the like.

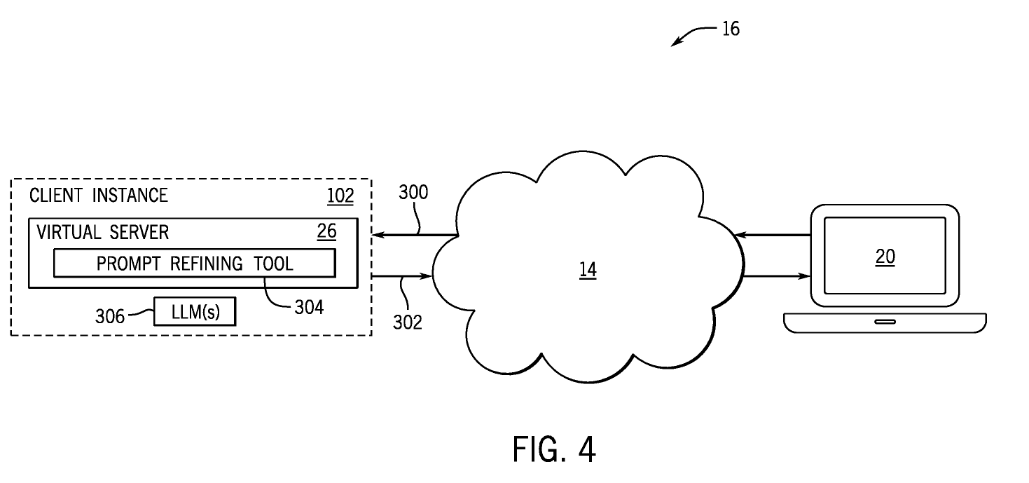

With the preceding in mind, FIG. 4 is a block diagram illustrating an embodiment in which a virtual server 26 supports and enables the client instance 102, according to one or more disclosed embodiments. More specifically, FIG. 4 illustrates an example of a portion of a service provider cloud infrastructure, including the cloud-based platform 16 discussed above. The cloud-based platform 16 is connected to a client device 20 via the network 14 to provide a user interface to network applications executing within the client instance 102 (e.g., via a web browser or a native application running on the client device 20). The client instance 102 is supported by virtual servers 26 similar to those explained with respect to FIG. 2, and is illustrated here to show support for the disclosed functionality described herein within the client instance 102. Cloud provider infrastructures are generally configured to support a plurality of end-user devices, such as client device(s) 20, concurrently, wherein each end-user device is in communication with the single client instance 102. Also, cloud provider infrastructures may be configured to support any number of client instances, such as client instance 102, concurrently, with each of the instances in communication with one or more end-user devices. As mentioned above, an end-user may also interface with client instance 102 using an application that is executed within a web browser.

As shown, the client device 20 may interact with the client instance 102 by providing inputs 300, to which the client instance 102 may respond with outputs 302. In the embodiment shown in shown in FIG. 4, the virtual server 26 of the client instance 120 may run a prompt tuning tool 304, which may be a software application defined by code, accessible via a native application or web browser of the client device 20. Accordingly, the inputs 300 may include inputs such as a skill prompt, task description, a dataset for training and/or testing a large language model, and so forth. Correspondingly, the outputs 302 may include responses to inputs 300, a set of prompts, a summary of a prompt refining process, responses to the set of prompts, feedback generating during the prompt refining process, and so forth. The prompt tuning tool 304 may utilize one or more large language models 306 (LLMs), which may be stored within the client instance 102 or accessible to the client instance 102, to generate some or all of the outputs 302. As used herein, a large language model (LLM) is a probabilistic model of a natural language used for general-purpose language generation. LLMs typically include one or more artificial neural networks having a transformer-base architecture. LLMs learn statistical relationships from text documents through training processes that may be supervised, semi-supervised, or self-supervised. During training, LLMs may learn syntax, semantics, and/or ontology. LLMs, when used for text generation, receive an input text and iteratively predict the next word or token. It should be understood that the client instance 102 shown in FIG. 4 may be utilized by the client device 20 for other tasks associated with prompt refining, as well as tasks beyond the scope of prompt generation and modification.

The presently disclosed prompt tuning tool 304 receives natural language inputs and uses the LLMs 306 to automatically generate and refine prompts based on the inputs. As used herein, a “natural language” is intended to be understood to be a language, either written, typed, or spoken by a human being. Accordingly, a natural language input may be one or more human-readable alphanumeric character strings, or audio, the meaning of which may be understood by a human. In some embodiments, the prompt may be a template. For example, information may be extracted from a natural language input 300 (e.g., the skill prompt, the task description) and placed into the template of the prompt. Additionally, the prompt may include instructions for the LLM to utilize in generating a response to the prompt. As shown in FIG. 4, the prompt tuning tool 304 may receive the natural language input 300 from the client device, such as “I would like to summarize the attached documents.” The prompt tuning tool 304 may utilize the one or more LLMs 306 to generate a response, including generating and iteratively refining a prompt generated based on the input 300 to generate the response, as an output 302. The one or more LLMs 306 may be trained, for example, on the dataset of records of multi-turn conversational interactions, which may be sourced from client specific documents, transcripts, publicly available information, publications, data from the Internet, and so forth. In some embodiments, the one or more LLMs 306 may be “off the shelf” or “out of the box” LLMs 306 provided by a service provider and not unique to the client instance 102. However, in other embodiments, the LLMs may be customized to the client instance 102, either with specific training, specific customized settings, or both.

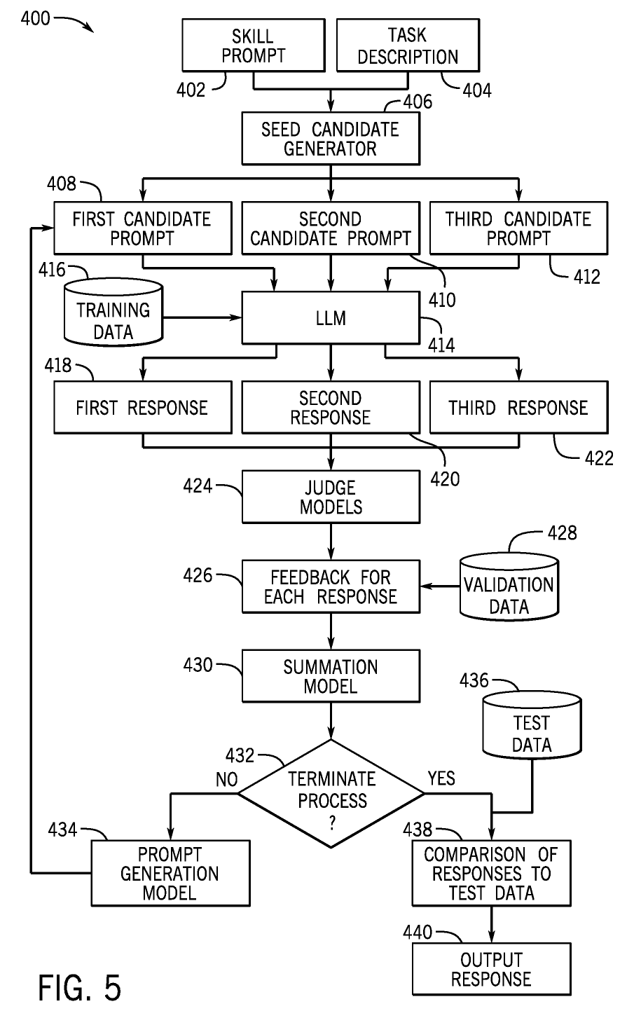

FIG. 5 is a block diagram of a process 400 for automatically, iteratively refining a set of prompts for an LLM. As such, the process 400 may repeat (i.e., iterate) certain steps. For example, the process 400 may generate a second set of prompts based on an evaluation of the first set of prompts and their respective response, may generate a third set of prompts based on an evaluation of the second set of prompts and their respective responses, and so on.

The computing system 10 may provide a skill prompt 402 and a task description 404 to a seed candidate generator 406. The skill prompt 402 may be a textual command from a user. For example, the skill prompt 402 may include “summarize the attached document,” “enter a ticket regarding an IT issue,” “identify profits and losses for the last quarter,” and the like. The task description 404 may include a description of the details of the task in the skill prompt 402 (e.g., determine next steps, determine a cause of the problem, etc.), an output structure for a response to the skill prompt 402, relevant data and documents, identification of relevant data and documents within a dataset, and the like. The seed candidate generator 406 may be a software package, or part of a package, defined by code executable by the processing circuitry.

The computing system 10, via the seed candidate generator 406, may generate a set of k prompts (e.g., 1, 2, 3, 4, 5, 6, and so on prompts) based on the skill prompt 402 and the task description 404. For example, as illustrated, the seed candidate generator 406 generates a first candidate prompt 408, a second candidate prompt 410, and a third candidate prompt 412. The seed candidate generator 406 may conduct a wide net search (e.g., a scatter-shot search, bootstrapping) to generate the prompts 408, 410, 412. For example, the seed candidate generator 406 may conduct a semantic search of a database of template prompts based on the skill prompt 402 and the task description 404 to generate the set of k prompts. As such, the prompts 408, 410, 412 may have varying scope. In some embodiments, the seed candidate generator 406 may be configurable, for example via an input from the client device 20, such that the seed candidate generator 406 generates a certain number of prompts.

The candidate prompts 408, 410, 412 may include instructions for responding to the skill prompt 402 and task description 404. In some embodiments, the candidate prompts 408, 410, 412 may include the skill prompt 402 and/or the task description 404.

In some embodiments, the computing system 10 may receive the dataset. The dataset may include text, strings, queries, sample responses, and the like. The computing system 10 may split the dataset into training data, validation data, test data, or any combination thereof. For example, the computing system 10 may assign a respective percentage of the dataset as each of training data, validation data, and test data. In some embodiments, the computing system 10 may assign the percentages of the dataset based on an input from the client device 20.

The computing system 10 may provide the candidate prompts 408, 410, 412 to a large language model (LLM) 414. The LLM 414 may be trained using the training data 416 of the dataset. Thus, the computing system 10, via the LLM 414, may generate a respective response for each prompt of the set of k prompts. For example, in the illustrated embodiment, the computing system generates, via the LLM 414, a first response 418 for the first candidate prompt 408, a second response 420 for the second candidate prompt 410, and a third response 422 for the third candidate prompt 412. In some embodiments, the computing system 10 may determine a training score based on how closely each response 418, 420, 422 matches the training data 416.

The computing system 10 may provide the responses 418, 420, 422 to one or more judge models 424. The judge models 424 may evaluate each of the responses 418, 420, 422 for a variety of response traits. In some embodiments, the judge models 424 may be one or more LLMs.

In some embodiments, each of the judge models 424 may evaluate the responses 418, 420, 422 for a different response trait. The response traits made include formatting of response, coherency of response, citations within a response, completeness of response, conciseness of response, groundedness, relevance to skill prompt 402 and/or task description 404, grammatical errors, self-reference, profanity, recency, and the like. For example, a formatting evaluation may include determining whether the response is formatted according to the task description 404. A coherency evaluation may include evaluating the readability and logic of the response. A citation evaluation may include evaluating the accuracy, format, and usage of citations within the response. A completeness evaluation may include determining whether all aspects of the skill prompt 402 and/or the task description 404 have been answered in the response. A conciseness evaluation may include determining whether the response is redundant and/or an appropriate length. A groundedness evaluation may include determining whether the information within the response is accurate (e.g., not a hallucination). A relevance evaluation may include determining whether the information in the response relates to a query or command of the skill prompt 402. A grammatical error evaluation may include determining if and which grammatical errors are present in the response. A self-reference evaluation may include determining whether the response includes information from sources generated by the LLM 414. A profanity evaluation may include determining whether the response contains profane and/or offensive language. A recency evaluation may include determining whether the response contains up-to-date information.

In some embodiments, the computing system 10 may be configurable or programmed such that the computing system 10 may evaluate certain response traits. The computing system 10 may, for example, add or remove one or more judge models 424 associated with a particular response trait. The computing system 10 may be configured via the client device 20. In some embodiments, the computing system 10 may automatically add or remove judge models 424. For example, the computing system 10 may remove a judge model 424 evaluating conciseness if a length of the response is not restricted. Alternatively, the computing system 10 may add a judge model 424 evaluating conciseness if a short response is preferred. As another example, the computing system 10 may remove a judge model 424 evaluating recency if the skill prompt 402 utilizes analysis of historical records. Alternatively, the computing system 10 may add a judge model 424 evaluating recency if the skill prompt 402 utilizes analysis of recent or current records.

The computing system 10, via the judge models 424, may generate feedback for each response 426. The feedback 426 may include comment(s), grade(s), a validation score, an explanation, or any combination thereof for each response 418, 420, 422. The comments may include textual descriptions of errors or issues with the response. For example, the textual descriptions may include phrases such as “misspelling of causality” and “third bullet point is redundant of the first bullet point.” The grade may be an indicator (e.g., a numerical, alphabetical, symbolic indicator) of the effectiveness of the response based on the evaluation. In some embodiments, the feedback 426 may include a comment for each response trait (e.g., a trait comment) and a grade for each response trait (e.g., a trait grade). In some embodiments, the computing system 10 may include an explanation for the comments and/or grades. For example, the computing system 10 may include an explanation for why a grade for a response is low (e.g., “the grade is low because the response includes irrelevant information and inaccurate information”).

In some embodiments, each response trait may be associated with an importance score (e.g., a multiplier or other weighting schema). The computing system 10 may multiply each trait grade for the response by the importance score of the response trait associated with the respective trait grade. As such, the computing system 10 may weigh response traits differently to appropriately prioritize the response traits. In some embodiments, a user may set the importance scores; that is, the computing system 10 may receive the importance scores from the client device 20. In some embodiments, the importance score for each response trait may increase or decrease as the computing system 10 completes iterations. For example, an importance score for grammatical errors may be 0.1 during a first iteration, 0.3 during a second iteration, and 0.5 during a third iteration. Thus, as errors and issues are resolved during the iterations, lower priority errors and issues may increase in priority and are more likely to be addressed.

The computing system may determine the grade (e.g., the overall grade) for the response 418, 420, 422 based on the trait grades. For example, the computing system 10 may sum the trait grades to determine the grade. As another example, the computing system 10 may average the trait grades to determine the grade. In some embodiments, the grade may be multiplied by a momentum multiplier based on the number of iterations completed. For example, a momentum multiplier for the first iteration may be 0.5, a momentum multiplier for the second iteration may be 1, and a momentum multiplier for the third iteration may be 0.7. The momentum multiplier ensures that each iteration is given an appropriate weight to improve a next set of prompts. For example, the middle iteration is given a greater momentum multiplier to ensure the computing system 10 aggressively narrows the scope of the prompts. However, as the scope narrows, the computing system lessens the momentum multiplier to ensure the next set of prompts covers an appropriate breadth.

In some embodiments, the computing system 10 may determine a validation score for each response 418, 420, 422 based on a comparison of each response 418, 420, 422 to the validation data 428 of the dataset. The validation score may correspond to how closely each response 418, 420, 422 matches the validation data 428. As such, a response that closely matches the validation data 428 may have a higher validation score, and a response that does not match the validation data 428 may have a lower validation score. The validation score may be a numerical, alphabetical, or symbolic indicator. The validation score may allow the computing system 10 to detect responses that are overfit to the training data 416. For example, a lower validation score may be indicative of a response that has been overfit to the training data 416.

Additionally, in some embodiments, the judge models 424 may evaluate each prompt 408, 410, 412 via the set of judge models 424. For example, it may be desirable to generate a concise prompt to reduce a cost associated with using the prompt within an LLM. As such, the computing system 10 may generate feedback associated with the conciseness of the prompt in addition to the effectiveness of the response. Furthermore, the computing system 10 may sum or average a grade associated with the prompt with the grade of the respective response.

The computing system 10 may provide the feedback for each response 426 to the summation model 430. The summation model 430 may be a large language model. The computing system 10 may generate, via the summation model 430, summarized feedback based on the feedback for each response 426. In some embodiments, the summation model may aggregate the feedback for each response 426 such that the summation model outputs summarized feedback for all responses 418, 420, 422. In other embodiments, the summation model may output summarized feedback for each response 418, 420, 422. The summarized feedback may include a common type of error, a number of occurrences of each type of error, a description of the highest priority errors, and the like. For example, the summarized feedback may include “redundant sentences: 4.” In some embodiments, the summation model 430 may take the importance score into account when determining which feedback to summarize. For example, the summation model may summarize feedback with an importance score over a threshold value. As another example, the summation model may summarize feedback for response traits with the highest importance scores.

The computing system 10 may store the prompts 408, 410, 412, the respective responses 418, 420, 422, the validation scores, the summarized feedback, and the like in a memory and/or database. As such, the computing system 10 may later reference the stored prompts and associated data to determine which prompt to use and/or which response to output to the client device 20.

The computing system 10 may determine whether to terminate the process 432. The computing system 10 may terminate the process 432 after a set number of iterations (e.g., 1, 2, 3, 4, 5, 6, and so forth) or upon a termination condition being met. The number of iterations may be set via an input from the client device 20. Alternatively and/or additionally, the computing system 10 may terminate the process 432 based on a grade and/or a validation score associated with one or more respective responses being below a threshold value. The computing system 10 may also terminate the process 432 if the training score decreases or remains constant after a certain number of iterations.

If the computing system 10 decides not to terminate the process 432, the computing system 10 may provide the task description 404, the prompts 408, 410, 412, the respective responses 418, 420, 422 for each prompt, the summarized feedback, or any combination thereof to a prompt generation model 434. The computing system may provide the prompts 408, 410, 412, the responses 418, 420, 422, and the feedback 426 as a single prompt. The prompt generation model 434 may generate a second set of k prompts. The second set of k prompts may have a narrower scope than the set of k prompts 408, 410, 412. The computing system 10 may thereafter repeat the process 400. For example, the computing system 10 may generate, via the LLM 414, a respective response for each of the second set of k prompts. The computing system 10 may also generate feedback, via the judge models 424, for each of the respective responses.

If the computing system 10 decides to terminate the process 432, the computing system 10 may receive test data 436 of the dataset. The computing system may conduct a comparison 438 of the respective responses for the sets of prompts (e.g., the stored prompts) to the test data 436. In some embodiments, the computing system 10 may conduct the comparison 438 of the respective responses for a subset of the stored prompts. For example, the computing system 10 may determine the subset of stored prompts based on the grades of the respective responses, the validation scores, the training score, or any combination thereof. Therefore, the computing system 10 may conduct comparisons for high accuracy and/or effective responses. Based on the comparison 438, the computing system 10 may determine a response to output 440, for example to the client device 20. Additionally, in some embodiments, the computing system 10 may store the selected response and its associated prompt in the database of template prompts to be used in the future.

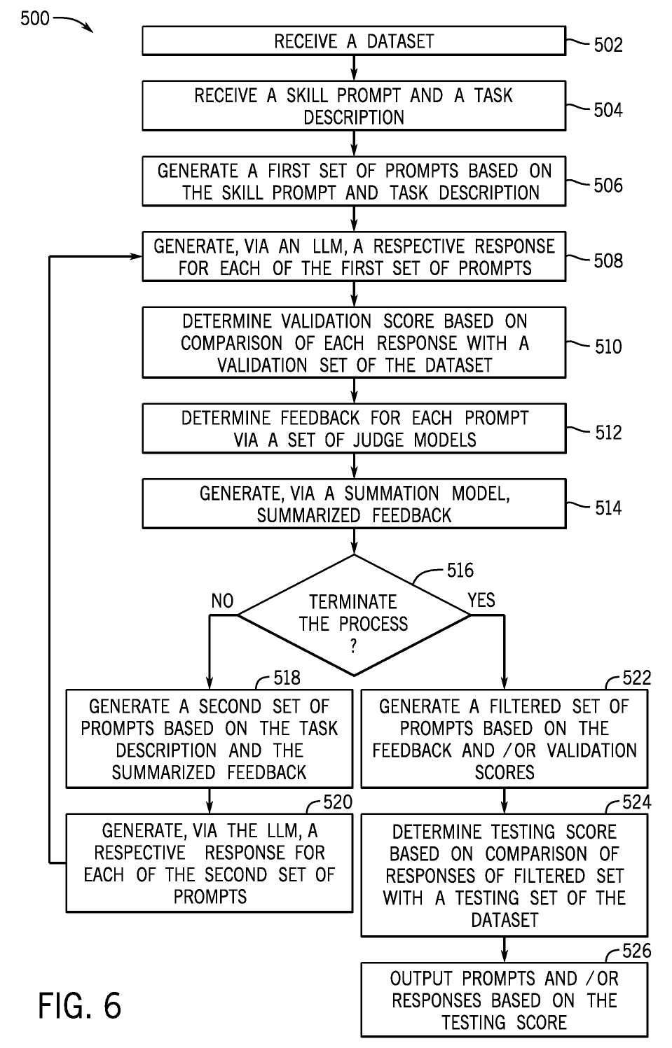

FIG. 6 is a flow chart of a process 500 for automatically refining a set of prompts over a number of iterations. The computing system 10 may perform the process 500 in response to receiving an input (e.g., receiving a skill prompt and/or a task description, etc.). Although the following description of the process 500 is described in a particular order and being performed by the computing system 10, it should be noted that the process 500 may be performed in any suitable order and by any suitable processing system. Further, it should be understood that, though shown in a sequential or serial manner for the purpose of illustration and explanation, in practice certain of the steps of processes may be performed in parallel or in a multithreaded manner, which may be more efficient in terms of time, computational cycles or bandwidth, and/or computational resources.

In process block 502, the computing system 10 may receive a dataset. The dataset may include text, strings, queries, sample responses, and the like. In some embodiments, the computing system 10 may divide the dataset into a training set (e.g., a first subset), a validation set (e.g., a second subset), a testing set (e.g., a third subset), or any combination thereof. For example, the computing system 10 may divide the dataset such that the training set includes 70% of the data from the dataset, the validation set includes 10% of the data from the dataset, and the testing set includes 20% of the data from the dataset. In some embodiments, the percentage of the dataset in each set may be configured via an input from the client device 20.

In process block 504, the computing system 10 may receive a skill prompt and a task description. The skill prompt may be a textual command. For example, the skill prompt may include “summarize the attached document,” “enter a ticket regarding an IT issue,” “identify profits and losses for the last quarter,” and the like. The task description may include a description of the details of the task in the skill prompt (e.g., determine next steps, determine a cause of the problem, etc.), an output structure for a response to the skill prompt, relevant data and documents, relevant data and documents within a dataset, and the like. The computing system 10 may receive the skill prompt and the task description from the client device 20, for example.

In process block 506, the computing system 10 may generate a first set of prompts based on the skill prompt and the task description. Each prompt may include instructions for responding to the skill prompt and task description. In some embodiments, the candidate prompts may include the skill prompt and/or the task description. The first set of prompts may contain any number of prompts (e.g., 1, 2, 3, 4, 5, 6, and so on). In some embodiments, the computing system 10 may be configurable, for example via an input from the client device 20, such that the first set of prompts contains a specific number of prompts. The computing system 10 may conduct a wide net search (e.g., a scatter-shot search, bootstrapping) to generate the first set of prompts. For example, the computing system 10 may conduct a semantic search of a database of template prompts based on the skill prompt and the task description to generate the first set of prompts. In some embodiments, the computing system 10 may provide the skill prompt and the task description to a large language model to generate the first set of prompts. The first set of prompts may be of varying scope such that the computer system 10 may evaluate different scopes concurrently, thereby increasing the efficiency of the process 500.

In process block 508, the computing system may generate, via a large language model (LLM), a respective response for each prompt of the first set of prompts. The LLM may be trained using the training set of the dataset. In some embodiments, the computing system 10 may determine a training score based on how closely the response matches the training set.

In process block 510, the computing system 10 may determine a validation score based on a comparison of each respective response with the validation set of the dataset. The validation score may correspond to how closely each respective response matches the validation data. As such, a response that closely matches the validation data may have a higher validation score, and a response that does not match the validation data may have a lower validation score. The validation score may be a numerical, alphabetical, or symbolic indicator. In some embodiments, the computing system 10 may determine one or more validation scores are above an upper-level threshold score. If so, the computing system 10 may terminate the process 500 and output a response with the highest validation score, thereby improving the efficiency of the process 500 and conserving computational resources. In some embodiments, the computing system 10 may determine one or more validation scores are below a lower-level threshold score. A validation score below the lower-level threshold score may indicate that the response is overfit to the training data. As such, the computing system 10 may disregard the responses and associated prompts with validation scores below the lower-level threshold score and/or terminate the process 500, thereby reducing the analysis conducted by the computing system 10, increasing efficiency of the process 500, and reducing resource consumption.

In process block 512, the computing system 10 may determine feedback for each prompt via a set of judge models. For example, the computing system 10 may evaluate the respective response for each of the first set of prompts to determine the feedback. Additionally, the computing system 10 may evaluate each prompt of the first set of prompts to determine the feedback. The set of judge models may include one or more judge models (e.g., 1, 2, 3, 4, 5, 6, and so forth). The judge models may be large language models. The set of judge models may evaluate each response and/or prompt for a variety of response traits. In some embodiments, the computing system 10 may perform the actions in process blocks 510 and 512 in a parallel or multi-thread manner.

In some embodiments, each judge model of the set of judge models may evaluate a different response trait. The response traits made include formatting of a response, coherency of a response, citations within a response, completeness of a response, conciseness of a response, groundedness, relevance to skill prompt 402 and/or task description 404, grammatical errors, self-reference, profanity, recency, and the like. In some embodiments, the computing system 10 may be configurable such that the computing system 10 may evaluate different response traits. For example, one or more judge models associated with different response traits may be added or removed from the set of judge models via an input from the client device 20 or automatically via the computing system 10. Therefore, the process 500 may be customized to best respond to the skill prompt and task description, which may produce more accurate and relevant responses as well as reducing the amount of analysis done to reach the more accurate and relevant responses.

As described, the set of judge models may generate feedback for each response and/or prompt. The feedback may include comments and/or grades for each response and/or prompt. The comments may include textual descriptions of errors or issues with the response and/or prompt. The grade may be a numerical, an alphabetical, or a symbolic indicator of the effectiveness of the response and/or prompt based on the evaluation of the set of judge models. In some embodiments, the feedback may include a comment for each response trait (e.g., a trait comment) and a grade for each response trait (e.g., a trait grade). In some embodiments, each response trait may be associated with an importance score (e.g., a multiplier). For each response and/or prompt, the computing system 10 may multiply each trait grade by the importance score of the response trait associated with the respective trait grade. As such, the computing system 10 may weigh the grades of response traits differently to appropriately prioritize the response traits. In some embodiments, the computing system 10 may receive the importance scores from the client device 20. Additionally, the importance score may increase, decrease, or remain constant based on a number of iterations the computing system 10 has completed. The computing system may sum or average each trait grade for a response to determine the grade (e.g., the overall grade) of the response and/or the prompt. Additionally, the computing system may aggregate (e.g., sum or average) the grades for the prompt and the respective response associated with the prompt. In some embodiments, the grade may be multiplied by a momentum multiplier based on the number of iterations completed to ensure that each iteration is given an appropriate weight to improve a next set of prompts.

In process block 514, the computing system 10 may generate, via a summation model, summarized feedback for each respective response. For example, the computing system 10 may provide the comments and/or the grades for each response to the summation model. As such, the computing system 10, via the summation model, may generate summarized feedback (e.g., summaries of the comments and/or the grades) for each response based on the comments and/or grades. In some embodiments, the summation model may factor in the importance score of each response trait when generating the summarized feedback. For example, the summation model may determine feedback exists for multiple response traits and may prioritize summarizing the feedback for the response traits with highest importance scores. Therefore, the computing system 10 may shorten the feedback to prioritize the most common or prominent issues. Additionally, summarizing the feedback may prevent overloading or confusing a language model used to generate the updated prompts.

The computing system 10 may store the set of prompts, the respective responses, the validation scores, the summarized feedback, and the like in a memory and/or database. As such, the computing system 10 may later reference the stored prompts and associated data to determine which prompt to use and/or which response to output to the client device 20.

In decision block 516, the computing system 10 may determine whether to terminate the process 500. For example, the computing system 10 may terminate the process 500 after a set number of iterations or upon a termination criterion being reached. In some embodiments, the number of iterations may be set via an input from the client device 20. The computing system 10 may also terminate the process 500 based on a grade and/or a validation score associated with one or more respective responses being below a threshold value, thereby ending the process 500 when the accuracy and/or effectiveness of prompts is no longer improving and thus reducing resource consumption. The computing system 10 may additionally terminate the process 500 if the training score decreases or remains constant after a certain number of iterations, similarly ending the process 500 when the accuracy and/or effectiveness of prompts is no longer improving and thus reducing resource consumption.

If the computing system 10 decides not to terminate the process 500, the computing system 10 may generate a second set of prompts based on the first set of prompts, the respective responses, the feedback associated with each respective response, and any combination thereof in process block 518. In some embodiments, the computing system 10 may combine the first set of prompts, the respective responses, and the feedback into a single entry. The single entry may be provided to a prompt generation model (e.g., an LLM). As such, the computing system 10 may decide whether to generate the second set of prompts based on all of the prompts of the first set of prompts or a subset of the first set of prompts. For example, in some embodiments, the computing system 10 may generate the second set of prompts based on prompts exceeding a threshold validation score or a threshold grade from the first set of prompts. As such, the computing system 10 may narrow the scope of the prompts and result in improved responses that more accurately and effectively respond to the skill prompt.

In process block 520, the computing system 10 may generate, via the LLM, a respective response for each of the second set of prompts. The computing system 10 may then repeat the process 500. For example, the computing system 10 may provide the respective responses for the second set of prompts to determine a validation score for each response in process block 510.

If the computing system decides to terminate the process 500, the computing system 10 may generate a filtered set of prompts from the stored prompts based on the feedback and/or validation scores (e.g., the grades of the respective responses, the validation scores, the training score, or any combination thereof) in process block 522. The computing system 10 may generate the filtered set of prompts by selecting one or more of the stored prompts. For example, the computing system 10 may select n stored prompts with the highest validation scores, highest grades, or both. Alternatively, the computing system 10 may select stored prompts with validation scores and/or grades over a threshold value. In some embodiments, the computing system 10 may select the stored prompts based on a balancing of the grades, the validation scores, the training scores, or any combination thereof. As an example, the computing system 10 may select the stored prompts with both high validation scores and high training scores. As such, the computing system 10 ensures the set of filtered prompts includes the prompts and responses with the highest accuracy and effectiveness.

In process block 524, the computing system 10 may determine a testing score based on a comparison of responses of the filtered set of prompts to the testing set of the dataset. Similar to the validation score, the testing score may correspond to how closely each response matches the testing set. As such, a response that closely matches the testing set may have a higher testing score, and a response that does not match the testing set may have a lower testing score. This comparison ensures the respective responses match the entire dataset and are not overfit to the training data and/or validation data.

In process block 526, the computing system 10 may output one or more prompts and/or responses based on the testing scores. For example, the computing system 10 may output x prompts and/or respective responses with the highest testing scores. Alternatively, the computing system 10 may output the prompts and/or respective responses with testing scores above a threshold value. The computing system 10 may output the prompts and/or responses to the client device 20. In some embodiments, the computing system 10 may output the one or more prompts to the client device 20 and receive an input from the client device 20 that selects a prompt of the one or more prompts to use. The computing system 10 may then output the respective response of the selected prompt to the client device 20. In some embodiments, the computing system 10 may store the selected prompt and the respective response in the database of template prompts to be used in the future, thereby reducing the resource consumption and cost associated with generating refined prompts.

Various embodiments disclosed herein are directed to a system and method for autonomously refining AI prompts. In some embodiments, the system may receive a dataset including text, strings, queries, sample responses, and the like. The system may split the dataset into a training set (e.g., a first subset), a validation set (e.g., a second subset), and a testing set (e.g., a third subset). The system may receive a skill prompt (e.g., summarize, locate, etc.) and a task description. The system may conduct a search (e.g., a wide net search, a scatter shot search, a semantic search) based on the skill prompt and task description to generate a first set of candidate prompts. Additionally and/or alternatively, the system may generate the first set of candidate prompts via a prompt generation model (e.g., a large language model (LLM)).

Once the set of candidate prompts are generated, the system may then evaluate the effectiveness of each prompt. In some embodiments, for each prompt of the set of candidate prompts, the system may generate a respective response using the prompt and the training data. In particular, the system may iterate through the training set, at each iteration providing the prompt, the skill prompt, the task description, and a query of the training set to a model (e.g., an LLM) to generate a respective response.

In some embodiments, the system may compare the respective response to the validation set. For example, the system may determine whether the respective response is within a similarity threshold of the validation set. Additionally, the system may determine a validation score for the respective response based on the similarity of the respective response to the validation set.

In some implementations, the system may analyze the respective response via a plurality of judge models. Each of the judge models may be a respective LLM trained to provide a grade and a comment (collectively, feedback) for the respective response for a particular response trait. For example, the response traits may include formatting, coherency of response, completeness of response, conciseness of response, groundedness (e.g., hallucination detection, accuracy of information in response), relevance to the skill prompt and/or task description, citation accuracy, lack of grammatical errors, and the like. In some embodiments, the system may remove or add judge models for particular response traits. For example, the system may remove a judge model evaluating conciseness if a length of the response is not restricted. Alternatively, the system may add a judge model evaluating conciseness if a short response is required. In some embodiments, each response trait may be associated with an importance score (e.g., a multiplier). The grade for each response trait for the respective response may be multiplied by its associated importance score to ensure the response trait is given appropriate weight. The system may sum or average each grade for each response trait for the respective response to determine an overall grade for the response. Additionally, the system may summarize the comments associated with the respective response for each response trait via a language model.

For each prompt of the first set of candidate prompts, the system may provide the first set of candidate prompts along with the respective summarized feedback for each of the respective responses, the respective grade for each of the respective responses, and the task description to a prompt generation model (e.g., LLM) to generate a second set of candidate prompts. In particular, the prompt generation model may be configured to generate a second set of candidate prompts that address the feedback associated with each prompt of the first set of candidate prompts. The system may provide the second plurality of candidate prompts and the training set to the model to generate a respective response for each of the second set of candidate prompts, as described above. The system may repeat the process (e.g., response analysis and evaluation, prompt generation) for a set number of cycles or until an nth prompt outputs responses that are not within the similarity threshold of the validation set.

The system may use the validation score and/or the grade to filter the candidate prompts into one or more filtered candidate prompts. In some embodiments, the system may output all of the filtered candidate prompts and receive an input selecting which filtered candidate prompt to use. In some embodiments, the system may compare the responses associated with the filtered candidate prompts to the testing set (e.g., determine whether the responses are within a similarity threshold of the testing set) and output the filtered candidate prompt associated with the response with a highest similarity to the testing set.

The technical effects of certain embodiments of this disclosure may provide a system for automatically refining AI prompts. As such, the system may reduce manual operations, automatically customize prompts for each language model, and improve the language model’s performance. Furthermore, the system may be configurable such that the prompts and responses may be customized for the particular task. For example, the system may add or remove judge models for certain response traits as appropriate to complete the task. The system may generate a set of prompts with varying scopes. The system may then evaluate a respective response for each of the set of prompts, allowing the system to concurrently evaluate the effectiveness of prompts with varying scopes. The system may evaluate the responses based on a variety of response traits. The system may generate feedback based on the evaluation including comments, which may be summarized and provided to a prompt generation model to generate improved prompts and grades, which may be used to determine the effectiveness of the response. Additionally, each grade for a response trait may be multiplied by an importance score such that the system appropriately prioritizes the response traits. The system may generate an additional set of prompts with varying scope based on the set of prompts, the respective responses, and the feedback. Thus, the additional set of prompts may narrow in scope and result in improved responses that more accurately and effectively respond to the skill prompt.

The system may also use a dataset. For example, the LLM that generates the responses may be trained on a first subset of the dataset. The system may compare the responses to a second subset of the dataset to ensure the responses are not overfit to the first subset. Additionally, the system may compare the responses to a third subset of the dataset to determine candidate responses to potentially output such that the computing system ensures the candidate responses are accurate across the entire dataset. The system may then output one or more responses based on the validation score and the training score such that the system outputs the response that most accurately and effectively responds to the skill prompt. Furthermore, the system may store the response associated with the output response in a database of template prompts such that the refined prompt may be reused, thus reducing the resource consumption and the cost associated with generating refined prompts. Therefore, the system provides a consistent, automatic process that is reproducible, traceable, and time and resource efficient.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]…” or “step for [perform]ing [a function]…”, it is intended that such elements are to be interpreted under 35 U.S.C. 112(f). However, for any claims containing elements designated in any other manner, it is intended that such elements are not to be interpreted under 35 U.S.C. 112(f).

1. A method comprising:
receiving a skill prompt and a task description;
generating a first plurality of candidate prompts based on the skill prompt and the task description;
for each prompt of the first plurality of candidate prompts:
generating, via a large language model (LLM), a respective response based on the respective prompt; and
determining, via a plurality of judge models, feedback associated with the respective response;
generating a second plurality of candidate prompts based on the first plurality of candidate prompts and the respective feedback associated with each of the respective responses for each prompt of the first plurality of candidate prompts; and
for each prompt of the second plurality of candidate prompts:
generating, via the LLM, a respective response based on the respective prompt.

2. The method of claim 1, further comprising:
for each prompt of the second plurality of candidate prompts:
determining, via the plurality of judge models, second feedback associated with the respective response;
generating a third plurality of candidate prompts based on the second plurality of candidate prompts and the respective feedback associated with each of the respective responses for each prompt of the second plurality of candidate prompts; and
generating, via the LLM, a third plurality of responses based on the third plurality of candidate prompts.

3. The method of claim 1, wherein the generating a second plurality of candidate prompts is via a prompt generation LLM.

4. The method of claim 1, wherein each of the plurality of judge models are trained to determine feedback for a different response trait.

5. The method of claim 4, wherein the different response traits comprise formatting, citation, completeness, conciseness, groundedness, relevance, or any combination thereof.

6. The method of claim 4, comprising adding or removing a judge model for a certain response trait from the plurality of judge models.

7. The method of claim 4, wherein determining feedback comprises:
determining a trait grade and a trait comment for each response trait for each respective response;
generating the grade for each respective response based on a summation or an average of the trait grades for the respective response;
generating the comment for each respective response via a summation model based on the trait comment for the respective response; and
combining the grade and the comment for each respective response to determine the feedback.

8. The method of claim 7, further comprising:
receiving a multiplier associated with each response trait; and
multiplying the trait grade for each response trait for each of the respective responses by the multiplier.

9. The method of claim 1, comprising:
receiving a dataset;
for each prompt of the first plurality of candidate prompts:
wherein generating, via the LLM, the respective response is based on the first plurality of candidate prompts and a first subset of the dataset; and
determining a validation score for the respective response based on a comparison of the respective response to a second subset of the dataset;
filtering the first plurality of candidate prompts into one or more filtered candidate prompts based on the validation scores; and
outputting a response associated with one or more of the filtered candidate prompts based on a comparison of the respective responses to a third subset of the dataset.

10. The method of claim 1, comprising:
receiving a dataset;
for each prompt of the first plurality of candidate prompts:
wherein generating, via the LLM, the respective response is based on the first plurality of candidate prompts and a first subset of the dataset; and
comparing the respective response to a second subset of the dataset;
determining a respective response associated with a prompt of the first plurality of candidate prompts is within a similarity threshold of the second subset of the dataset; and
outputting the respective response.

11. The method of claim 1, further comprising:
determining, via a plurality of judge models, feedback associated with each prompt of the first plurality of candidate prompts;
aggregating the feedback associated with each prompt and the feedback associated with the respective response; and
wherein generating the second plurality of candidate prompts is based on the first plurality of candidate prompts and the aggregated feedback.

12. A system comprising:
processing circuitry; and
a non-transitory memory, accessible by the processing circuitry and storing instructions that, when executed by the processing circuitry, cause the processing circuitry to perform operations comprising:
receiving a skill prompt and a task description;
generating a first plurality of candidate prompts based on the skill prompt and the task description;
for each prompt of the first plurality of candidate prompts:
generating, via a large language model (LLM), a respective response based on the respective prompt; and
determining, via a plurality of judge models, feedback associated with the respective response;
generating a second plurality of candidate prompts based on the first plurality of candidate prompts and the respective feedback associated with each of the respective responses for each prompt of the first plurality of candidate prompts; and
for each prompt of the second plurality of candidate prompts:
generating, via the LLM, a respective response based on the respective prompt.

13. The system of claim 12, wherein the instructions cause the processing circuitry to perform operations further comprising:
for each prompt of the second plurality of candidate prompts:
determining, via the plurality of judge models, second feedback associated with the respective response;
generating a third plurality of candidate prompts based on the second plurality of candidate prompts and the respective feedback associated with each of the respective responses for each prompt of the second plurality of candidate prompts; and
generating, via the LLM, a third plurality of responses based on the third plurality of candidate prompts.

14. The system of claim 12, wherein each of the plurality of judge models are trained to determine feedback for a different response trait.

15. The system of claim 14, comprising adding or removing a judge model for a certain response trait from the plurality of judge models.

16. The system of claim 12, wherein the instructions cause the processing circuitry to perform operations further comprising:
receiving a dataset;
for each prompt of the first plurality of candidate prompts:
determining a validation score for the respective response based on a comparison of the respective response to a subset of the dataset; and
determining a response to output in response to one or more validation scores of the respective responses being below a threshold value.

17. The system of claim 16, wherein determining a response to output is based on the feedback associated with the respective responses, the validation scores, or both.

18. A non-transitory, computer readable medium comprising instructions that, when executed by processing circuitry, cause the processing circuitry to perform operations comprising:
receiving a skill prompt and a task description;
generating a first plurality of candidate prompts based on the skill prompt and the task description;
for each prompt of the first plurality of candidate prompts:
generating, via a language model (LLM), a respective response based on the respective prompt;
determining, via a plurality of judge models, feedback associated with the respective response;
generating a second plurality of candidate prompts based on the first plurality of candidate prompts and the respective feedback associated with each of the respective responses for each prompt of the first plurality of candidate prompts; and
for each prompt of the second plurality of candidate prompts:
generating, via the LLM, a respective response based on the respective prompt.

19. The non-transitory, computer readable medium of claim 18, wherein the instructions cause the processing circuitry to perform operations comprising:
for each prompt of the second plurality of candidate prompts:
determining, via the plurality of judge models, second feedback associated with the respective response;
generating a third plurality of candidate prompts based on the second plurality of candidate prompts and the respective feedback associated with each of the respective responses for each prompt of the second plurality of candidate prompts; and
generating, via the LLM, a third plurality of responses based on the third plurality of candidate prompts.

20. The non-transitory, computer readable medium of claim 18, wherein the instructions cause the processing circuitry to perform operations comprising:
receiving a dataset;
for each prompt of the first plurality of candidate prompts:
wherein generating, via the LLM, the respective response is based on the first plurality of candidate prompts and a first subset of the dataset;
determining a training score for the respective response based on a comparison of the respective response to the first subset of the dataset; and
determining a validation score for the respective response based on a comparison of the respective response to a second subset of the dataset;
filtering the first plurality of candidate prompts into one or more filtered candidate prompts based on the training scores and the validation scores; and
outputting one or more prompts of the filtered candidate prompts based on a comparison of the respective responses to a third subset of the dataset to a client device.
